(19) United States
(12) Patent Application Publication
(10) Pub. No.: US 2005/0139081 A1
(43) Pub. Date: Jun. 30, 2005

(54) Insulated sleeve for iced beverages

(76) Inventor: Daniel R. Lima, Taunton, MA (US)

Correspondence Address: BARLOW, JOSEPHS & HOLMES, LTD., 101 DYER STREET, 5TH FLOOR, PROVIDENCE, RI, 02903, US

(21) Appl. No.: 11/022,161

(22) Filed: Dec. 23, 2004

Related U.S. Application Data
(60) Provisional application No. 60/532,930, filed on Dec. 29, 2003.

(51) Int. Cl. A23F 3/00

(52) U.S. Cl. 99/275

(57) ABSTRACT

An insulated sleeve for an iced beverage cup having a cup body and a lid snap received on the cup body. The sleeve has a sidewall with a top end and a bottom end, the bottom end being closed by a bottom wall. The beverage cup is received within the sidewall. An annular elastic lip secured to the top end of the sidewall and extending radially inwardly is received over an outer peripheral edge of the lid and retains the lid in assembled relation with the beverage cup.

### CROSS-REFERENCE TO RELATED APPLICATION

This application claims priority to earlier filed U.S. Provisional Application Ser. No. 60/532,930 filed Dec. 29, 2003, the contents of which are incorporated by reference.

### BACKGROUND AND SUMMARY OF THE INVENTION

The present invention relates to insulating sleeves for beverages, and in particular to an insulating sleeve having a unique design configured and arranged for use with a cup of iced coffee.

There has been a recent surge in the popularity of iced beverages, particularly iced coffee and iced fruit drinks. The majority of these drinks are sold in clear plastic cups with a removable lid. The clear plastic cups provide a decorative presentation of the drinks in that the color of the drink shows through the clear sides of the cup. However, in areas of the country having high humidity and warm temperatures, the smooth outside surface of the plastic cups tend to accumulate condensation. The accumulated condensation drips down the side of the cup and often forms a pool of water around the bottom of the cup. When the beverage cup is placed into a cup holder in a vehicle, this condensation drips into the bottom of the cup holder and is generally an undesirable situation. Further, if the cup is left on a desk or other work surface, the condensation can damage a wood desk surface of saturate work papers in the area of the cup. Generally speaking, it would be desirable to reduce or eliminate this undesirable effect of drinking iced beverages, particularly iced-coffee, which has become popular for coffee breaks at work and in the car.

As a solution to the identified problem, the present invention provides an insulated sleeve which is particularly configured and arranged to snugly receive a conventional disposable iced beverage cup. A typical cup has a bottom wall with frustoconical sidewalls and a circular snap cover with a straw opening in the center. The present sleeve has a complimentary frustoconical shape with a bottom wall, and frustoconical side walls formed from a neoprene material (rubber interior with a fabric cover). The inner rubber provides the insulating function keeping the plastic from sweating, while also keeping the beverage cold for a longer period of time. The fabric outer surface of the neoprene material also provides a surface for imprinting logos and other printed indicia for advertising. The inner dimensions of the sleeve match the outer dimensions of the cup for a snug fit. The top edge of the sidewall of the sleeve includes an elastic lip which extends radially inwardly. There are several other embodiments of the sleeve, some of which include a vertical zipper which allows expansion of the sleeve and easier insertion of the cup into the sleeve, and a vertical window to see how much beverage is left in the cup. In yet another embodiment, the top edge of the side wall is heat staked to form a curled upper lip which extends over the top edge of the cup.

Accordingly, among the objects of the instant invention are: the provision of an insulating sleeve for a iced beverages and the provision of an insulating sleeve having a printable surface for accepting advertising materials and logos.

Other objects, features and advantages of the invention shall become apparent as the description thereof proceeds when considered in connection with the accompanying illustrative drawings.

### DESCRIPTION OF THE DRAWINGS

In the drawings which illustrate the best modes presently contemplated for carrying out the present invention:

FIG. 1 is a perspective view of a conventional clear plastic iced beverage cup;

FIG. 2 is a perspective view of a first embodiment of the insulating sleeve of the present invention with the beverage cup received therein;

FIG. 3 is another perspective view thereof with the sleeve rotated to show both the zipper and the window features;

FIG. 4 is yet another perspective view focusing on the window slot feature;

FIG. 5 is still another perspective view showing use of the sleeve with a cup having an alternative cover member;

FIG. 6 is a cross-sectional view thereof as taken along line 6-6 of FIG. 1; and

FIG. 7 is a perspective view of an alternate embodiment wherein the upper lip is heat staked into an inwardly curved configuration, and the zipper extends up through the top edge of the sleeve to separate the mating surfaces of the upper lip.

### DESCRIPTION OF THE PREFERRED EMBODIMENT

Referring now to the drawings, the present invention provides an insulated sleeve which is particularly configured and arranged to snugly receive a conventional disposable iced beverage cup.

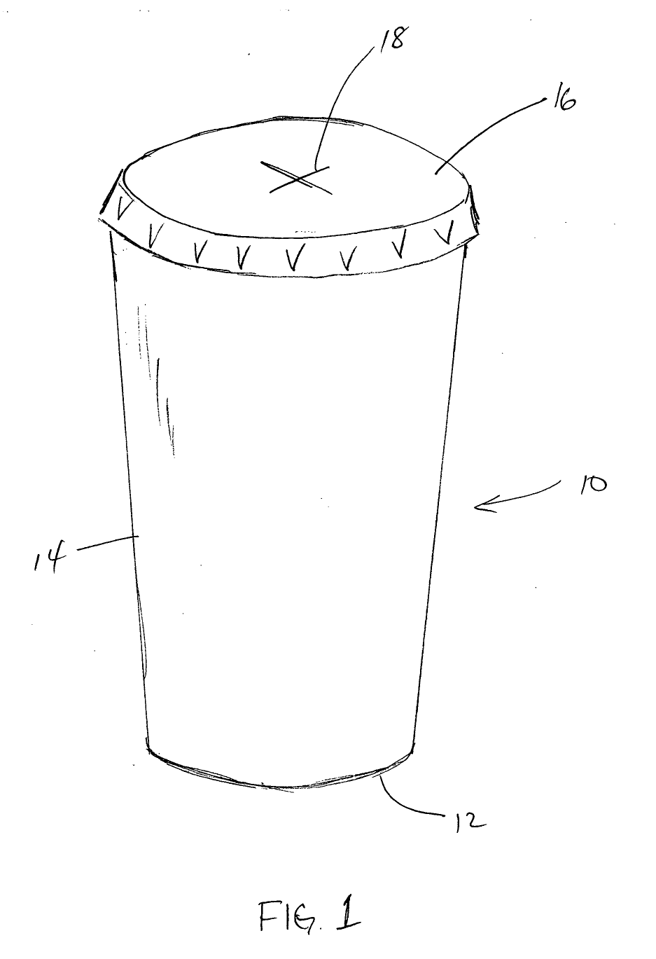

Referring to FIG. 1, a typical iced beverage cup generally designated at 10 has a bottom wall 12 with frustoconical sidewalls 14 and a circular snap cover 16 with a straw opening 18 in the center.

Referring now to FIGS. 2-4, the present sleeve is generally indicated at 20 and includes a complimentary frustoconical shape with a bottom wall 22, and frustoconical side walls 24 formed from a neoprene material (rubber interior 26 with a fabric cover 28 on both inner and outer sides (See FIG. 7)). The inner rubber 26 material provides the insulating function to keep the plastic cup surfaces 12, 14 from sweating, while also keeping the beverage cold for a longer period of time. The fabric outer surfaces 28 of the neoprene material also provides a surface for imprinting logos and other printed indicia (not shown) for advertising. The inner dimensions of the sleeve 20 match the outer dimensions of the cup 10 for a snug fit. The top edge of the sidewall 24 of the sleeve 20 includes an elastic lip 30 which extends radially inwardly. The elastic lip 30 comprises a thin strip of elastic material sewn on to the top edge of the neoprene material around the entire periphery of the side wall 24 forming a closed loop. The elastic material allows the cup 10 to be inserted into the interior of the sleeve 20 while also providing an upper boundary to keep the sleeve 20 firmly in place on the cup 10 and further to prevent the lid 16 from coming off the cup 10. It has been found that the elastic lip 30 will in fact reduce the chances of the lid 16 coming off of the cup 10, if the cup is accidentally knocked over.

There are several other embodiments of the sleeve, some of which may include a vertical zipper 32 which allows expansion of the sleeve 20 and easier insertion of the cup 10 into the sleeve 20. As shown in FIGS. 2-5, the zipper 32 is used in combination with the elastic lip 30. In this case, the zipper 32 provides additional expansion of the sleeve 20 for insertion of the cup 10. Once the cup 10 is in place, the zipper 32 can alternatively be used as a pocket opening in the sidewall 24 of the sleeve 20 to hold money, or other items. This feature could be useful, for example, when traveling to the beach to hold money, etc.

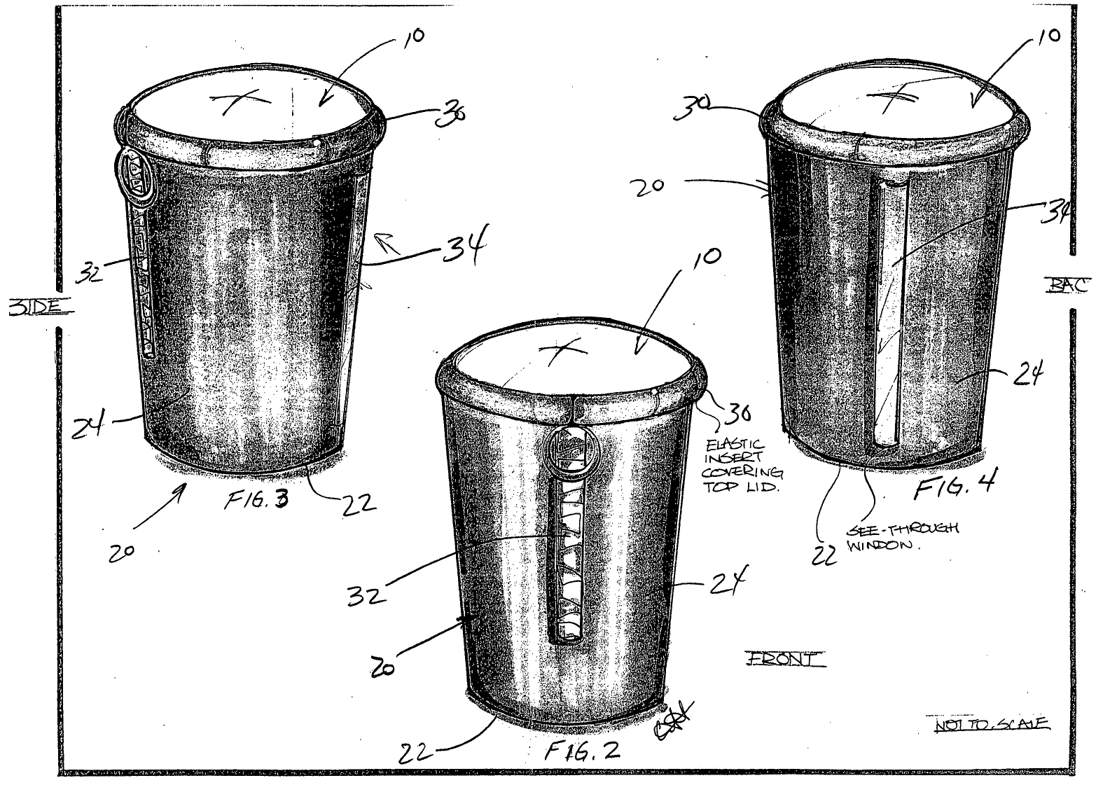

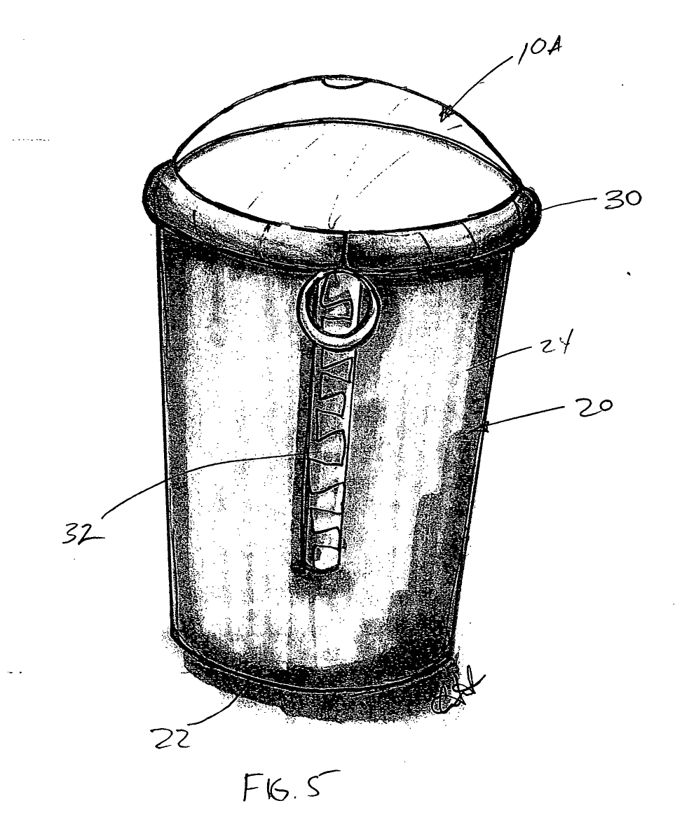

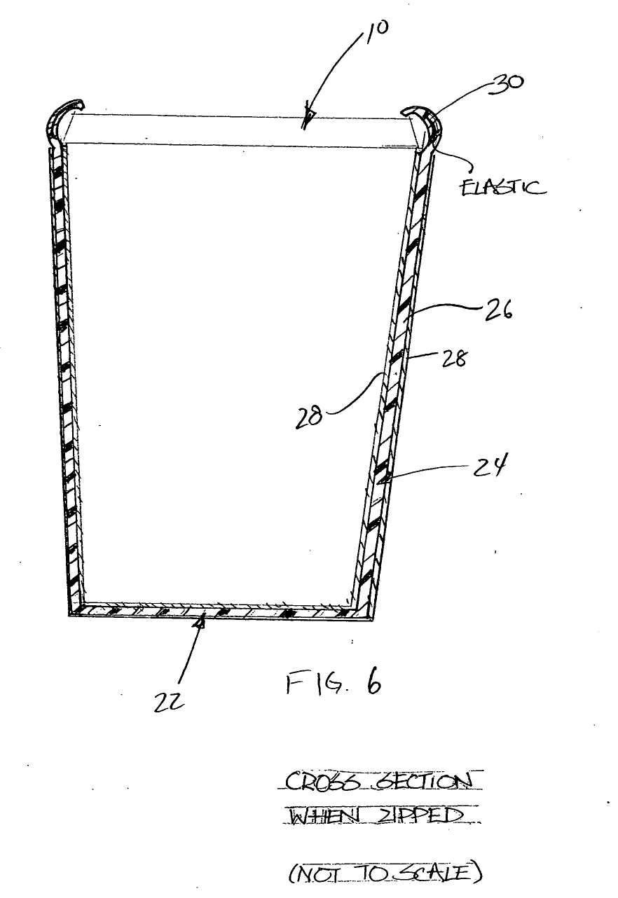

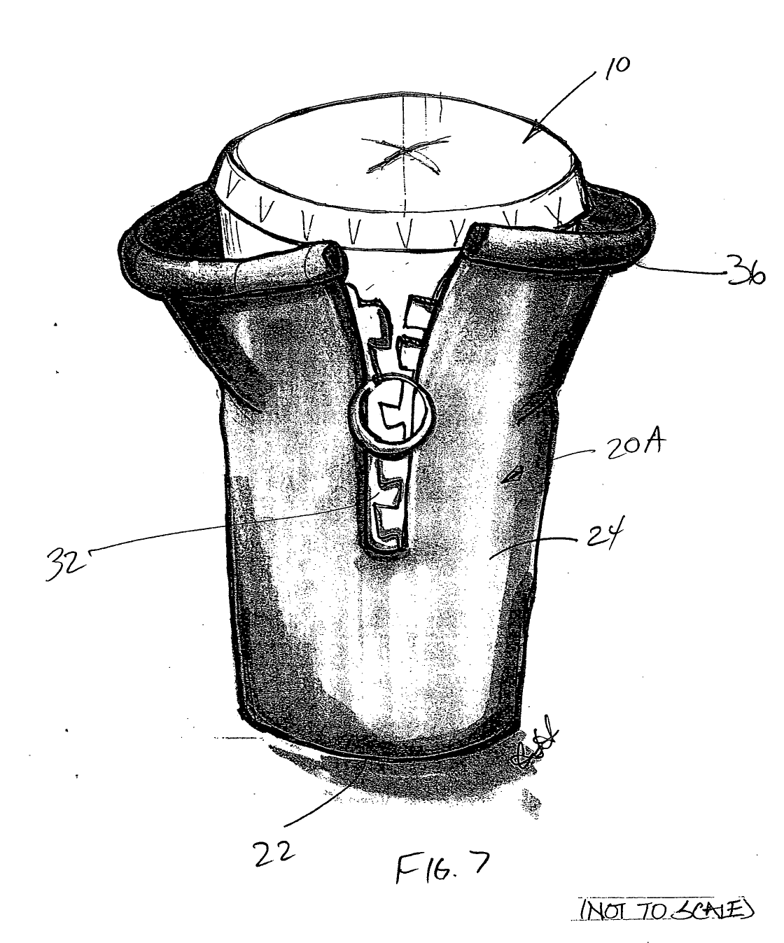

Another embodiment of the invention includes a vertical window 34 to see how much beverage is left in the cup 10 (See FIGS. 3 and 4). The window 34 could be left empty, i.e. as a slot in the sidewall 24, or could comprise a strip of clear plastic sewn into the neoprene material.

Referring now to FIG. 7, in yet another embodiment generally indicated at 20A, the top edge of the sidewall 24 is heat staked to form a curled upper lip 36 which extends over the top edge of the cup 10. The heat staked feature would replace the elastic lip 30 and would potentially reduce manufacturing costs as well as provide easier insertion of the cup 10. In this embodiment, the heat staking step would partially melt the neoprene material forming a hard curved lip to securely hold the cup within the sleeve 20A.

It can therefore be seen that the present invention provides a unique and novel insulating sleeve for an iced beverage. The sleeve is configured and arranged to snugly receive the cup and prevent the cup from “sweating” and from damaging desks, car interiors etc. For these reasons, the instant invention is believed to represent a significant advancement in the art which has substantial commercial merit.

While there is shown and described herein certain specific structure embodying the invention, it will be manifest to those skilled in the art that various modifications and rearrangements of the parts may be made without departing from the spirit and scope of the underlying inventive concept and that the same is not limited to the particular forms herein shown and described except insofar as indicated by the scope of the appended claims.

1. An insulated sleeve for an iced beverage cup comprising a cup body and a lid snap received on the cup body, said sleeve comprising:
a side wall including a top end and a bottom end, the bottom end closed by a bottom wall, said cup body being received within said sidewall; and
an annular elastic lip secured to the top end of the sidewall and extending radially inwardly over an outer peripheral edge of said lid for retaining said lid in assembled relation with said beverage cup.

2. The sleeve of claim 1, further comprising: a closure on the sidewall that allows expansion of the sleeve for easier insertion of said beverage cup.

3. The sleeve of claim 2, wherein the closure is a zipper.

4. The sleeve of claim 1, further comprising: a window on the sidewall to reveal the level of beverage remaining in said beverage cup.

5. The sleeve of claim 4, wherein the window is made of a transparent plastic material.

6. The sleeve of claim 1, wherein the sleeve is made of neoprene material.

7. An insulated sleeve for an iced beverage cup comprising a cup body and a lid snap received on the cup body, said sleeve comprising:
a side wall including a top end and a bottom end, the bottom end closed by a bottom wall, said cup body being received within said sidewall; and
a closure on the sidewall; the closure allowing expansion of the sleeve for easier insertion of said beverage cup; and
an annular elastic lip secured to the top end of the sidewall and extending radially inwardly over an outer peripheral edge of said lid for retaining said lid in assembled relation with said beverage cup.

8. The sleeve of claim, further comprising: a window on the sidewall to reveal the level of beverage remaining in a beverage cup.

9. The sleeve of claim 8, wherein the window is made of transparent plastic material.

10. The sleeve of claim, wherein the closure is a zipper.

11. The sleeve of claim, wherein the sleeve is made of neoprene material.

12. An insulated sleeve for an iced beverage cup comprising a cup body and a lid snap received on the cup body, said sleeve comprising:
a side wall including a top end and a bottom end, the bottom end closed by a bottom wall, said cup body being received within said sidewall;
a window on said sidewall to reveal the level of beverage remaining in said beverage cup;
a closure on the sidewall; the closure allowing expansion of the sleeve for easier insertion of said beverage cup; and
an annular elastic lip secured to the top end of the sidewall and extending radially inwardly over an outer peripheral edge of said lid for retaining said lid in assembled relation with said beverage cup.

13. The sleeve of claim, wherein the sleeve is made of neoprene material.

14. The sleeve of claim, wherein the closure is a zipper.

15. The sleeve of claim, wherein the window is made of a transparent plastic material.
